(19) United States
(12) Patent Application Publication
(10) Pub. No.: US 2007/0091736 A1
(43) Pub. Date: Apr. 26, 2007

(54) System and method for storing and managing digital content

(75) Inventors: Allan Dale, Haslett, MI (US); Thomas Bayerl, Williamston, MI (US); Craig Lyle Mahaney, Milan, MI (US); David M. Eberlein, Saline, MI (US); Ricky L. Haubenstricker, Saline, MI (US); Venkat B. Rao, Ann Arbor, MI (US)

Correspondence Address: DICKINSON WRIGHT PLLC, 1901 L. STREET NW, SUITE 800, WASHINGTON, DC, 20036, US

(73) Assignee: Lectronix, Inc.

(21) Appl. No.: 11/247,795

(22) Filed: Oct. 10, 2005

(51) Int. Cl. G11B 21/08

(52) U.S. Cl. 369/30.19

(57) ABSTRACT

A system and method for storing and managing digital content is disclosed. Uncompressed digital content is obtained and automatically stored on a memory device, such digital content becoming immediately available to a user from the memory device. Imperceptibly to the user, the digital content is compressed, the compressed content is stored on the memory device and the uncompressed content is deleted from the memory device. The user shall have complete access to the digital content at all times, and is unaware in what format (compressed or uncompressed) such content is present.

### BACKGROUND OF THE INVENTION

The present invention is generally directed to a system and method for storing and managing digital content and, more particularly, to an audio system and method that automatically stores audio content from a compact disc (CD) onto a hard disk drive, or other memory device, upon insertion of the CD, compresses the audio content and stores the compressed audio content on the memory device upon request of a user, such that the compression and storage of the compressed audio content do not interfere with the availability of the audio content to the user, i.e., at all times the user can play the audio content without interruption.

It is increasingly common that consumers record the contents of their audio CD's onto a variety of digital storage media. Many consumers use the hard disk drives of their personal computers (PC's) to hold large libraries of audio content that have been copied from their CD collection. Recently, some dedicated audio systems have introduced the capability to record audio tracks from CD's and store the music in internal digital media such as a hard disk drive or FLASH memory storage. The use of these types of memory devices have the added benefit of eliminating the problems associated with playing music directly from a CD, for example, skipping due to scratches on the CD or jostling of the CD player, malfunction due to an obscured laser, etc.

Although audio CD's store their music in a digital format (e.g., Redbook CDA format) that can be directly copied to digital media, the native format of the audio used on such CD's requires a relatively large amount of memory for each song. There are several standard and widely supported algorithms for compressing the audio content used on standard audio CD's. These algorithms are able to reduce the amount of memory needed to store audio content by approximately 90% and still retain acceptable audio quality. Such compression (also referred to as “encoding”) is almost always used as part of the storing process to reduce the amount of memory consumed by the stored audio content. The most common of these compression standards used today is .MP3 format, although other similar algorithms exist.

Regardless of whether the compression system is a personal computer or dedicated audio device, the process of obtaining and compressing the audio content (commonly referred to as “ripping”) has the same basic steps:
1. Detect the insertion of an audio CD,
2. Utilize a database to identify the music information (CD artist, album name, song titles),
3. Identify the starting and ending location of tracks (referred to as the table of contents or TOC),
4. Transfer the digital audio tracks from the audio CD to the hard disk,
5. Compress the contents of the audio tracks on the hard disk,
6. Store the information about the recorded audio tracks into a database (library), and
7. Allow the user to browse and play the songs from the library.

When the above process is run on personal computers today, the central processing unit (CPU) that executes these steps is normally an extremely powerful device. While some of the steps involved in the compression and storage process require a lot of CPU processing (particularly the compression), a standard desktop computer has a powerful enough processor to run these steps in real time while maintaining reasonable speed from the user's perspective. However, dedicated audio products, such as a car radio or home CD player, generally do not have powerful processors. Typically, these types of devices use the least powerful CPU as possible, because there are significant cost, power, and thermal issues in using high-end processors in such devices. Therefore, because the full power of the processor is needed, these devices usually become unusable during the compression and storage process. The result is that the user has to wait for the processor in the device to finish the compression and storage process before being able to operate the device as intended.

Despite the many solutions to increase the speed of the compression and storage process so as to reduce the inconvenience to the user that have been proposed, an efficient system and method of storing and managing digital content has yet to be satisfactorily addressed in the art.

### SUMMARY OF THE INVENTION

In view of the above, a need exists for a system and method of storing and managing digital content on an electronic device. More particularly, a need exists for a system and method of storing and managing digital content that is transparent to the user of an electronic device, i.e., from the perspective of the user, the electronic device is operating completely normally, whether or not the device is in the process of compressing and storing the digital content.

To meet these and other needs that will be apparent to those skilled in the art based upon this description and the appended drawings, the present invention is directed to a system for storing and managing digital content that comprises a content acquisition device that is capable of obtaining the digital content in a first format. The system further comprises a processor, operably connected to the content acquisition device, and a memory device, which is also operably connected to the processor. The processor is capable of automatically directing the storage of the digital content in the first format on the memory device when the content acquisition device obtains the digital content, as well as executing the digital content in the first format. The system operates as follows. The processor is able to execute the digital content in the first format that is stored on the memory device substantially simultaneously with the storage of the digital content on the memory device. The processor is further capable of transforming the digital content from the memory device to a second format simultaneously with the executing of the digital content in the first format. Finally, the processor is capable of directing the storage of digital content in the second format to the memory device simultaneously with the executing of the digital content in the first format.

In another embodiment of the present invention, a method of storing and managing digital content on an electronic apparatus is disclosed. The method comprises obtaining the digital content in a first format, executing the digital content in the first format, automatically storing the digital content in the first format on a memory device upon obtaining the digital content, executing the digital content in the first format stored on the memory device substantially simultaneously with the step of automatically storing the digital content on the memory device, and transforming the digital content from the memory device to a second format and storing the digital content in the second format to the memory device.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is a partial schematic view of a system for storing and managing digital content according to one embodiment of the present invention;

FIG. 2 is a flow chart illustrating the steps of the system when a play request is received according to one embodiment of the present invention;

FIG. 3 is a flow chart illustrating the steps of the ripping thread according to one embodiment of the present invention

FIG. 4 is a flow chart illustrating the steps of the encoding thread according to one embodiment of the present invention; and

FIG. 5 is a flow chart illustrating the steps of the cleanup thread according to one embodiment of the present invention.

### DETAILED DESCRIPTION OF THE PREFERRED EMBODIMENT

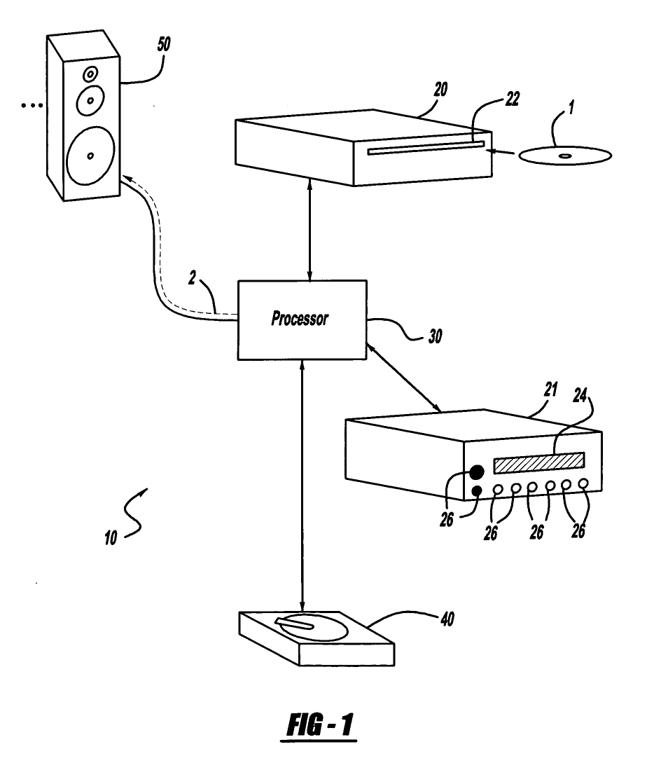

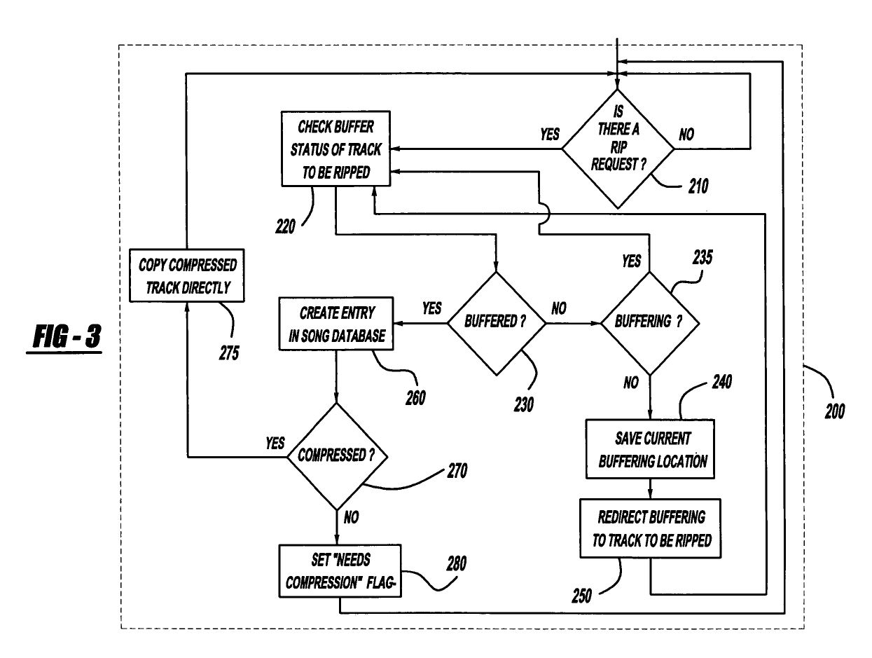

A system and method for storing and managing digital content according to the present invention is described with reference to FIGS. 1-5. It should be appreciated that the applications for the system and method for storing and managing digital content according to the present invention may be used in a variety of applications beside the illustrated system. For example, the present invention may be used with a digital versatile disc (DVD) player where the digital content to be managed and stored comprises audio and visual information.

A preferred embodiment of the present invention is illustrated in FIG. 1. Audio system 10 comprises a CD drive or player 20, an interface 21, a processor 30, memory device 40 and speaker apparatus 50. The audio system 10 may be used in any number of environments, e.g., a vehicle entertainment system, a portable audio device, a home entertainment system or a desktop computer. In a preferred embodiment of FIG. 1, the illustrated audio system 10 is adapted for use in an automobile stereo system.

The CD drive 20 may be one of any number of designs that are well known in the art. The illustrated CD drive 20 includes a CD insertion recess 22 that is capable of receiving a CD 1 when inserted therein. The interface 21 comprises output display 24 and input knob and buttons 26, and allows a user to interact with the audio system 10. The CD drive 20 is capable of receiving a CD 1, scanning the content of the CD 1 via a laser, and sending that content to the processor 30 for playing the audio content resident on the CD 1. The output display 24 of the interface 21 may be used to display the content of the CD 1 and various other messages or information to the user of the audio system 10, as is well known in the art. Further description of the components of the CD drive 20 and interface 21 is omitted because of the ubiquity of CD players in the prior art and further, as far as concerns the present invention, the exact details and components of the CD drive 20 and interface 21 themselves are irrelevant.

The CD drive 20 is capable of obtaining the audio content present on the CD 1. The audio content on the CD 1 is normally stored in a number of uncompressed files (or tracks) in a digital format, for example, the Redbook CDA format. During the reading of the CD 1, the processor 30 converts the Redbook CDA formatted audio content into a signal 2 that is output to the speaker apparatus 50. The speaker apparatus 50 can be of one of any number of the well known designs in the art, and is designed to convert the output signal 2 to an audible signal for the user.

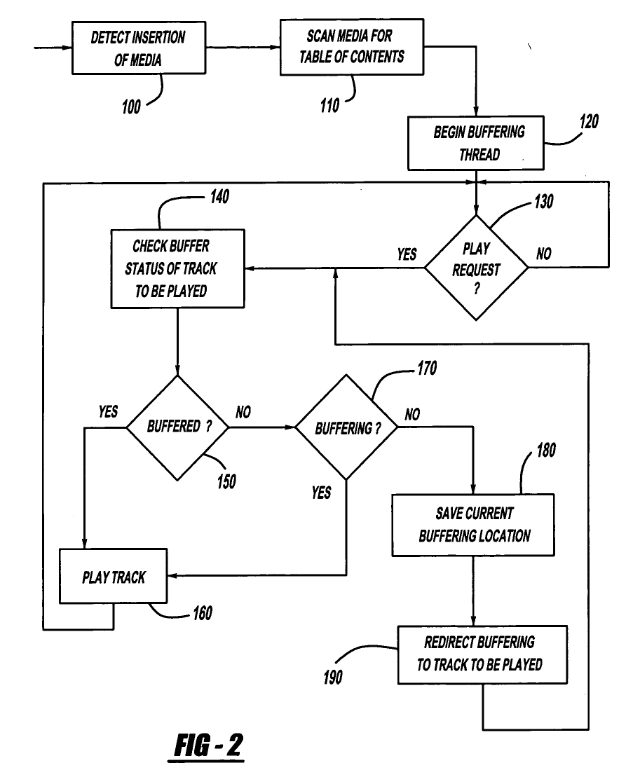

In the present invention, upon insertion of the CD 1 in the CD drive 20, the audio content is automatically obtained and stored on a memory device, which is illustrated as hard disk drive 40 in FIG. 1, although any other form or number of memory devices could be utilized (e.g., FLASH memory, RAM, etc.). The processor 30 directs this storage process. In a preferred embodiment illustrated in FIG. 2, this initial storage is accomplished by means of a buffering thread. The buffering thread's role is to buffer the entire contents of the CD 1 as digital data files to the hard disk drive 40. When the insertion of the CD 1 is detected at step 100, the processor 30 reads the table of contents to determine track locations of the CD 1 at step 110, and then begins the buffering thread with the first track at step 120. The buffering thread is designed to proceed at the maximum defined transfer speed of the CD drive 20. In a preferred embodiment, and because the buffering thread is a simple I/O operation, a direct memory access (DMA) transfer process is used. A DMA transfer is the preferred mechanism of the buffering thread because it requires a minimal amount of resources of the processor 30, however other methods of copying the CD content onto the hard disk drive 40 are within the scope of the present invention.

Because the transfer speed of the CD reader 20 is normally greater than real time playback speed (typically 2-4 times faster), each of the tracks may be played from the hard disk drive 40 as soon as the buffering thread has begun buffering that track. Thus, the present invention permits playing the tracks directly from the hard disk drive 40 a few seconds after a CD 1 is inserted into the CD drive 20. This completely eliminates the problems, described above, associated with playing a CD 1 directly from the CD drive 20. If the user selects a track that has not yet begun being buffered, the processor 30 saves the current buffering location, redirects the buffering to the newly selected track for play, and begins playing the track while it is being buffered. This process is more fully described below.

In a preferred embodiment, the user of the audio system 10 is presented with a listing of the tracks on the CD 1 by means of the output display 24 immediately after the processor 30 has read the table of contents. The user may interact with the audio system 10 by manipulating the input knobs/buttons 26 of the interface 21 shown in FIG. 1, although any other form of interaction (e.g., use of remote control, voice control, etc.) is within the scope of the invention. The user's interaction with the audio system 10 may be to control its volume, select the track to be played, or any other known form of interaction. In addition to these common interactions known in the prior art, the user will be able to select tracks to be compressed and stored (i.e., ripped). This selection may occur at any time, including while the tracks from the CD 1 are being transferred at high speed to the hard disk drive 40. Once a user requests to play a track at step 130, the system checks the buffer status of the requested track (step 140). At step 150, if the track has been buffered, the buffered track is played 160. If the track is not buffered at step 150, the system checks whether the track is currently being buffered at step 170. If the track is currently being buffered, the system directs the track to be played at step 160 because, as discussed above, the buffering process is quicker than a play process and a track may be played while being buffered. If the track is not buffering at step 170, the system saves the current buffering location 180, redirects the buffering to the track to be played 190, and returns to step 140 to check the buffer status of the track. The process described immediately above is performed within the buffering thread, and takes priority over the ripping thread 200 described below. In this manner, the user of the audio system 10 remains completely unaware of the status of the buffering and ripping 200 threads,

Once the user has selected a track for ripping, that track is added to a rip request queue. In a preferred embodiment, the processor 30 is constantly monitoring the rip request queue for tracks to rip, shown at step 210. This constant monitoring is called the ripping thread 200. After a rip request for a track is detected by the processor 30 at step 210, the ripping thread 200 first determines the buffer status for the track at step 220. If the track has not already been buffered, the ripping thread determines if the track is currently being buffered at step 235. If the track is currently buffering, the system returns to step 220 and determines the buffer status for the track. If the track is not being currently buffered at step 235, the processor requests the buffering thread activity to be redirected to that track at step 250. Before switching to a new track, however, the system first saves the current buffering location at step 240. By allowing the track buffering to be interrupted without loss of work and allowing tracks to be buffered out of order, the invention is the most responsive system possible while ensuring the quickest time to buffer the complete media. Shorter buffering time means more flexible play opportunities for the user sooner, even while ripping is in progress.

Continuing with a preferred embodiment, once the processor 30 determines that a track is completely buffered at step 230, the ripping thread 200 creates an entry for that track in a song database, resident on the memory device 40, at step 260. This entry and the track information that has been buffered are used to create a .WAV file (which is the usual CD 1 content format with added information, e.g., a header and footer) or other audio file located in the song database area. The song database entry contains information about the song including, but not limited to, song title, artist name, album name, genre, and the track location, depending on the availability of this information. At step 270, the processor 30 determines whether or not the track that has just been entered into the song database is in compressed or uncompressed format. If the track is already in a compressed format (e.g., the CD 1 content included tracks in .MP3 format), the system copies the compressed track directly at step 275 and returns to step 210 to ascertain if there is another rip request. If the track is in an uncompressed format (e.g., .WAV format), the processor 30 sets the “needs compression” flag for this track at step 280, and then returns to step 210 to ascertain if there is another rip request. At this point, the track is a fully functional track available for play from the song database or library. Even encoding the file, should it be applicable, will not affect the availability of the track. Only if the user deletes the file from the library will the availability of the track be changed.

From the user's viewpoint, the storage process is complete as soon as the requested tracks have been transferred onto the hard disk drive 40 as .WAV files and added to the song database. At this time, the user can eject the CD 1 from the CD player 20, playback the stored music from the song library, and even insert a new CD 1 and begin the process described above with a new CD 1. The user is unaware of the compression status of the recently recorded music. An encoding thread 300 will eventually compress the tracks imperceptibly to the user, but the user can freely play the songs prior to the compression.

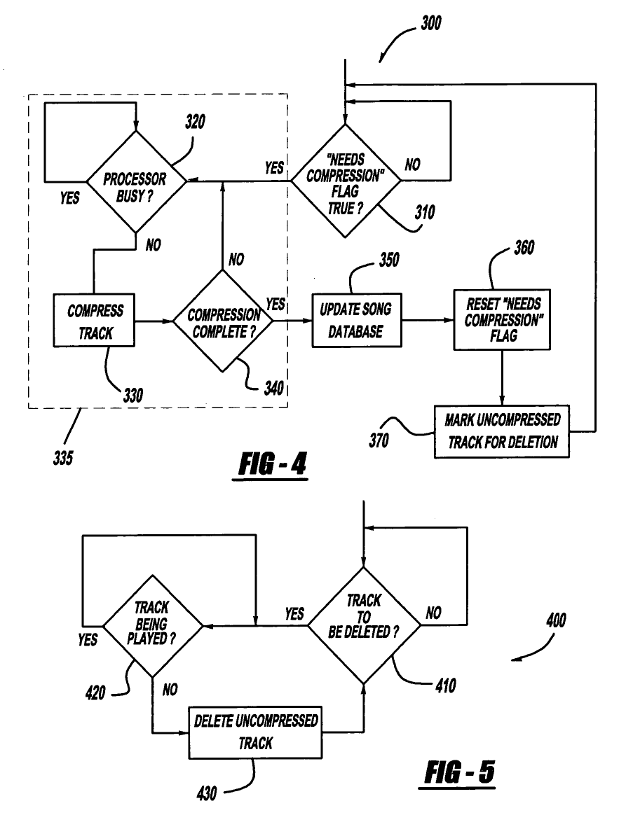

The encoding thread 300 exists as a low priority process of the processor, that is, the encoding process is accomplished during a period of low processor activity and only when higher priority processes are idle. At step 310, the encoding thread 300 continually searches the song database for tracks with the “needs compression” flag set to true. Upon finding a “needs compression” flag set to true, the processor 30 is scanned to determine if adequate resources are available to compress the track at step 320. If the processor 30 is busy, the encoding thread 300 monitors the processor 30 to determine when it becomes available. If the processor 30 is available, the processor 30 is directed to begin creating a compressed version of the track by encoding it with a compression algorithm, as shown at step 330. The new compressed file will also be located in the song database area. During the compression process, indicated by dashed box 335, the processor 30 activity is scanned pursuant to step 320 to determine whether it remains available for the task of compression 330. The compression process 330 is a background process, and may be interrupted by other, higher priority processes (e.g., the buffering thread, playing the audio content). The embodiment illustrated in FIG. 4 is one implementation of a background process, however other prioritization processes are within the scope of the present invention. No matter the implementation of the prioritization process, the user is unaware of the status of the encoding and sees no negative performance effects from the encoding thread 300, even in the event that the track currently being played is also being encoded.

Once the file compression is complete at step 340, the encoding thread 300 updates the song database at step 350 such that the specified track will now point to the compressed file (as opposed to the uncompressed file). In a preferred embodiment, the song database is only used to determine the track location prior to playing a track, and therefore changing the database will not affect the track currently being played. After updating the song database, the encoding thread 300 resets the “need compression” flag for the track at step 360. Finally, at step 370 the encoding thread 300 marks the uncompressed file for deletion by creating an entry in a cleanup database. This database contains a list of files that should be deleted from the hard disk drive 40, the process for which will be described below.

The cleanup thread 400 is another low priority process resident on the processor 30 and is illustrated in FIG. 5. As shown in step 410, the cleanup thread 400 continually searches the cleanup database for files to delete. Once a file marked for deletion is found, the cleanup thread 400 first determines if the file is currently being played, shown at step 420. This is possible if, for example, the current file being played is the track that has been most recently compressed. Once the file is no longer being played, the cleanup thread will delete it at step 430. The deletion process 430 may be accomplished by actually erasing the track from the memory device or, preferably, by unprotecting the memory locations for that file and allowing them to be rewritten in the future. The cleanup thread 400 frees valuable hard drive space so the user can store a large quantity of content.

One skilled in the art will recognize that many processors of the type normally used in the system and with the method of the present invention are capable of advanced multitasking and prioritization schemes, such that the processor may be running many threads, processes and/or programs concurrently. Therefore, it is possible (and, in fact, probable) that all of the threads described above may be active at the same time. For instance, the processor may be concurrently buffering a track (the buffering thread), while also ripping another track (the ripping thread 200), encoding yet another track (the encoding track 300) and deleting yet again another track (the cleanup thread 400). In addition, the present invention is not limited to priority scheme described above. For example, making the cleanup thread 400 the first priority of the system (in order to ensure maximum allowable free space on the memory device 40) is within the scope of the present invention, as are any other possible prioritization schemes.

One of the crucial novel aspects of the present invention is the ability of the user to begin playing the track(s) immediately after insertion of the CD 1 into the CD reader 20, while also being able to store track(s) for future use. The user of the system and method of the present invention merely has to insert the CD and choose the track(s) for playing and/or storing. As far as the user is concerned, a track is immediately available for playing (and is stored) at all points after the buffering of that track has begun. Thus, once a user inserts a CD with a track and chooses that track for storage, from that moment until the user chooses to delete the track, the track is available for playing by the system. The system and method of the present invention ultimately compresses and stores the track completely unbeknownst to the user, i.e., the user is unaware of whether or not the track is, is not, or is currently being compressed.

The above description describes a preferred embodiment of the present invention, however the method and system of the present invention can be utilized in other ways. For example, the above description generally revolves around an audio system and audio content, however the invention can be used with an audio/video system such as a DVD player where the user can store and compress combined audio/video files for play. Additionally, the present invention is perfectly adaptable for use with a computer system for use with audio, audio/video or other digital content. For example, the digital content to be stored, compressed and executed could comprise computer files so as to maximize the storage space available on the memory device. Further, the above description describes the CD drive 20, interface 21, processor 30 and hard disk drive 40 (and even the speaker apparatus 50) as separate elements, however one skilled in the art will readily recognize that these elements can be combined into one integral device, and it is not uncommon for portable digital audio devices to include all of those elements in one device. The modification of utilizing a different form of media (other than the CD 1 described above) from which to obtain the uncompressed digital content is also within the scope of the present invention. In other embodiments, the media could comprise a DVD, a FLASH memory device, a hard disk drive or other memory device, or even a file server accessed via a computer network or the internet.

Yet another embodiment of the present invention removes the need for user interaction to begin the ripping and encoding threads. In this embodiment, once an uncompressed track has been buffered, the system automatically copies the track onto the hard disk drive 40 (preferably as a .WAV file), adds the track to the song database, and sets the need compression flag for that track. The encoding thread will automatically begin to compress the track, as described above. If the track is already in a compressed format, the system stores the compressed track as an entry in the song database. The priority of the threads remains the same as that described described above. If a user chooses to store the track for future use, the system merely notes that the entry in the song database should be stored. If the user decides not to store the track, the system marks the entry to be deleted (described more fully above with respect to the cleanup thread 400). In this manner, the user remains unaware of the storage and compression status of a track, but every track that the user has chosen to store is available for play (in addition to those present on the current CD), whether or not those tracks are compressed. Further embodiments are within the scope of the invention, for example, a system in which the ripping thread is accomplished automatically but the encoding thread only begins upon user interaction, e.g., the user chooses to store the track. This could be accomplished, for example, by only setting the “needs compression” flag after a user chooses to store the track.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A system for storing and managing digital content, comprising:
a content acquisition device, said content acquisition device being capable of obtaining said digital content in a first format;
a memory device; and
a processor operably connected to said content acquisition device and said memory device, said processor being capable of automatically directing the storage of said digital content in said first format on said memory device when said content acquisition device obtains said digital content, wherein said processor is capable of:
executing said digital content in said first format stored on said memory device substantially simultaneously with the storage of said digital content on said memory device,
transforming said digital content from the memory device to a second format simultaneously with the executing of said digital content in said first format, and
directing the storage of digital content in said second format to said memory device simultaneously with the executing of said digital content in said first format.

2. The system of claim 1, wherein said digital content comprises audio information.

3. The system of claim 2, wherein said content acquisition device comprises an optical disc reader.

4. The system of claim 3, wherein said second format comprises an .MP3 file format.

5. The system of claim 4, wherein said transforming said digital content from the memory device to said second format comprises compressing said digital content.

6. The system of claim 5, wherein said transforming said digital content to said second format comprises a low-priority process of said processor.

7. The system of claim 1, wherein said processor is capable of executing said digital content in said second format stored on said memory device.

8. The system of claim 1, wherein said memory device comprises a hard disk drive.

9. The system of claim 1, wherein said processor is further capable of delaying the step of transforming said digital content from the memory device to said second format until a period of low activity of said processor.

10. An audio system, comprising:
a compact disc (CD) reader, said CD reader being capable of obtaining audio content from a CD;
a memory device; and
a processor operably connected to said CD reader and said memory device, said processor being capable of automatically directing the storage of said CD audio content on said memory device when said CD reader receives said CD, wherein said processor is capable of:
playing said CD audio content stored on said memory device substantially simultaneously with the storage of said CD audio content on said memory device,
compressing said CD audio content from the memory device into a compressed audio content simultaneously with the playing of said CD audio content, and
directing the storage of said compressed audio content to said memory device simultaneously with the playing of said CD audio content.

11. The audio system of claim 10, wherein said compressing said CD audio content from the memory device into said compressed audio content is a low-priority process of said processor.

12. The audio system of claim 10, wherein said memory device is a hard disk drive.

13. The audio system of claim 12, wherein said compressing said CD audio content from the memory device into said compressed audio content is a low-priority process of said processor.

14. The audio system of claim 10, wherein said compressed audio content comprises an .MP3 file format.

15. A method of storing and managing digital content on an electronic apparatus, comprising the steps of:
obtaining said digital content in a first format;
executing said digital content in said first format;
automatically storing said digital content in said first format on a memory device upon obtaining said digital content;
executing said digital content in said first format stored on said memory device substantially simultaneously with the step of automatically storing said digital content on said memory device; and
transforming said digital content from the memory device to a second format and storing said digital content in said second format to said memory device.

16. The method of claim 15, wherein the step of transforming said digital content from the memory device to said second format comprises determining a period of low activity of said electronic apparatus and compressing said digital content during said period.

17. The method of claim 15, wherein the steps of transforming said digital content from the memory device to said second format and storing said digital content in said second format to said memory device are performed imperceptibly to a user.

18. The method of claim 17, wherein the steps of transforming said digital content from the memory device to said second format and storing said digital content in said second format to said memory device are performed during the step of executing said digital content in said first format stored on said memory device.

19. The method of claim 15, further comprising the step of automatically deleting said digital content in said first format from said memory device upon completion of the step of storing said digital content in said second format to said memory device.

20. The method of claim 15, wherein the step of executing said digital content in said first format comprises playing CD audio content.
